(19) United States
(12) Patent Application Publication
(10) Pub. No.: US 2021/0229155 A1
(43) Pub. Date: Jul. 29, 2021

(54) BODYMAKER REDRAW ASSEMBLY

(71) Applicant: Stolle Machinery Company, LLC, Centennial, CO (US)

(72) Inventors: Karl S. Fleischer, Denver, CO (US); Daniel A. Jansen, Cincinnati, OH (US); Russell Bauer, West Chester, OH (US); Peter Frans Corssmit, Centennial, CO (US)

(73) Assignee: Stolle Machinery Company, LLC, Centennial, CO (US)

(21) Appl. No.: 17/155,122

(22) Filed: Jan. 22, 2021

Related U.S. Application Data
(60) Provisional application No. 62/965,191, filed on Jan. 24, 2020.

(51) Int. Cl. B21D 22/28; B30B 1/26

(52) U.S. Cl. CPC B21D 22/28; B30B 1/268

(57) ABSTRACT

A redraw assembly is for a bodymaker having a ram, a die pack, and a drive mechanism. The redraw assembly includes a carriage assembly, a ram guidance system, a hold down assembly, and a cam follower hold down frame.

### CROSS REFERENCE TO RELATED APPLICATION

This application claims priority to U.S. Provisional Patent Application Ser. No. 62/965,191, filed Jan. 24, 2020 entitled, BODYMAKER REDRAW ASSEMBLY.

### BACKGROUND

### Field

The disclosed concept relates generally to a can bodymaker and, more specifically, to a redraw assembly for a can bodymaker.

### Background Information

Generally, a can begins as a disk of metal, such as, but not limited to aluminum, also known as a “blank,” that is punched from a sheet or coil of metal. The blank is fed into a cupper. The cupper performs a blank and draw process to create a cup. That is, the blank is formed into a cup having a bottom and a depending sidewall. The cup is fed into one of several bodymakers, which perform a redraw and ironing operation. More specifically, the cup is disposed in a can forming machine at the mouth of a die pack having substantially circular openings therein. The cup is held in place by a redraw sleeve, which is part of the redraw assembly. The redraw sleeve is a hollow tubular construct that is disposed inside the cup and biases the cup against the die pack. The first die in the die pack is the redraw die, which is also a part of the redraw assembly. The cup is biased against the redraw die by the redraw sleeve. Other dies, the ironing dies, are disposed behind, and axially aligned with, the redraw die. The ironing dies are not part of the redraw assembly. An elongated, cylindrical ram having a punch at the forward, distal end is aligned with, and structured to travel through, the openings in the redraw die and the ironing dies. At the end of the die pack opposite the ram is a domer. The domer is a die structured to form a concave dome in the bottom of the cup/can.

Thus, in operation, a cup is disposed at one end of the die pack. The cup, typically, has a greater diameter than a finished can as well as a greater wall thickness. The redraw sleeve is disposed inside of the cup and biases the cup bottom against the redraw die. The opening in the redraw die has a diameter that is smaller than the cup. The ram, with the punch as the forward, distal end, passes through the hollow redraw sleeve and contacts the bottom of the cup. As the ram continues to move forward, the cup is moved through the redraw die. As the opening in the redraw die is smaller than the original diameter of the cup, the cup is deformed and becomes elongated with a smaller diameter. The wall thickness of the cup typically remains the same as the cup passes through the redraw die. As the ram continues to move forward, the elongated cup passes through a number of ironing dies. The ironing dies each thin the wall thickness of the cup causing the cup to elongate. The final forming of the can body occurs when the bottom of the elongated cup engages the domer, creating a concave dome in the cup bottom. At this point, and compared to the original shape of the cup, the can body is elongated, has a thinner wall, and a domed bottom. The can body is ejected from the ram, and more specifically the punch, for further processing, such as, but not limited to trimming, washing, printing, flanging, inspection and placement on pallets, which are shipped to the filler. At the filler, the cans are taken off of the pallets, filled, ends are placed (i.e., seamed) onto them, and then the filled cans are repackaged.

There is room for improvement in redraw assemblies for bodymakers.

### BRIEF DESCRIPTION OF THE DRAWINGS

A full understanding of the invention can be gained from the following description of the preferred embodiments when read in conjunction with the accompanying drawings in which:

FIG. 1 is a side elevation, partially schematic view of a bodymaker;

FIG. 2A is a side elevation view of the interior of a bodymaker showing a redraw assembly in accordance with a non-limiting embodiment of the disclosed concept;

FIG. 2B is an isometric view of the bodymaker and redraw assembly of FIG. 2A;

FIG. 2C is an isometric partially schematic view of portions of the bodymaker and redraw assembly also showing a pneumatic panel and features in accordance with aspects of the disclosed concept;

FIGS. 2D, 2E and 2F are enlarged views of segments A, B and C, respectively, of FIG. 2C;

FIG. 2G is another enlarged isometric view of the pneumatic panel;

FIG. 3 is an isometric view of the redraw assembly;

FIG. 4 is another isometric view the redraw assembly, also showing a redraw sleeve assembly for reference;

FIG. 5 is an isometric view of a cam follower hold down frame for the redraw assembly;

FIG. 6 is a top plan view of the cam follower hold down frame;

FIG. 7 is a section view taken along line A-A of FIG. 6;

FIGS. 8A and 8B are isometric views of a carriage assembly for the redraw assembly;

FIG. 9 is an enlarged view of segment A of FIG. 11;

FIG. 10 is an end elevation view of the carriage assembly;

FIG. 11 is a section view taken along line B-B of FIG. 10;

FIG. 12 is another isometric view of the carriage assembly;

FIG. 13 is an end elevation view of the carriage assembly;

FIG. 14 is a section view taken along line A-A of FIG. 13;

FIGS. 15A and 15B are top and bottom isometric views, respectively, of a ram guide cradle assembly for the redraw assembly;

FIG. 16 is an end elevation, partially in section, view of the ram guide cradle assembly;

FIG. 17 is a top plan, partially in section, view of the ram guide cradle assembly;

FIG. 18 is a section view taken along line E-E of FIG. 17;

FIG. 19 is an isometric view of a ram bushing assembly for the redraw assembly;

FIG. 20 is an end elevation view of the ram bushing assembly;

FIG. 21 is a section view of the ram bushing assembly taken along line A-A of FIG. 20;

FIG. 22 is another end elevation view of the ram bushing assembly;

FIGS. 23 and 24 are isometric views of a bushing cartridge for the ram bushing assembly;

FIG. 25 is an end elevation view of the bushing cartridge;

FIG. 26 is a section view taken along line A-A of FIG. 25;

FIG. 27 is an isometric view of an air spring assembly for the redraw assembly;

FIG. 28 is a top plan, partially in section, view of the air spring assembly;

FIG. 29 is an end elevation view of the air spring assembly;

FIG. 30 is a side elevation, partially in section, view of the air spring assembly; and

FIGS. 31-33 are isometric views of portions of the bodymaker and the redraw assembly, also showing removable features of the air spring assembly in accordance with aspects of the disclosed concept.

### DESCRIPTION OF THE PREFERRED EMBODIMENTS

Directional phrases used herein, such as, for example, clockwise, counterclockwise, left, right, top, bottom. upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Further, an object resting on another object held in place only by gravity is not “coupled” to the lower object unless the upper object is otherwise maintained substantially in place. That is, for example, a book on a table is not coupled thereto, but a book glued to a table is coupled thereto. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof.

As used herein, “engage,” when used in reference to gears or other components having teeth, means that the teeth of the gears interface with each other and the rotation of one gear causes the other gear to rotate as well. When used in reference to components other than gears, “engage” means that two or more parts or components exert a force or bias against one another either directly or through one or more intermediate elements or components.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, the word “unitary” means a component is created as a single piece or unit. That is, a component that includes pieces that are created separately and then coupled together as a unit is not a “unitary” component or body.

As used herein, the term “number” shall mean one or an integer greater than one (i.e., a plurality).

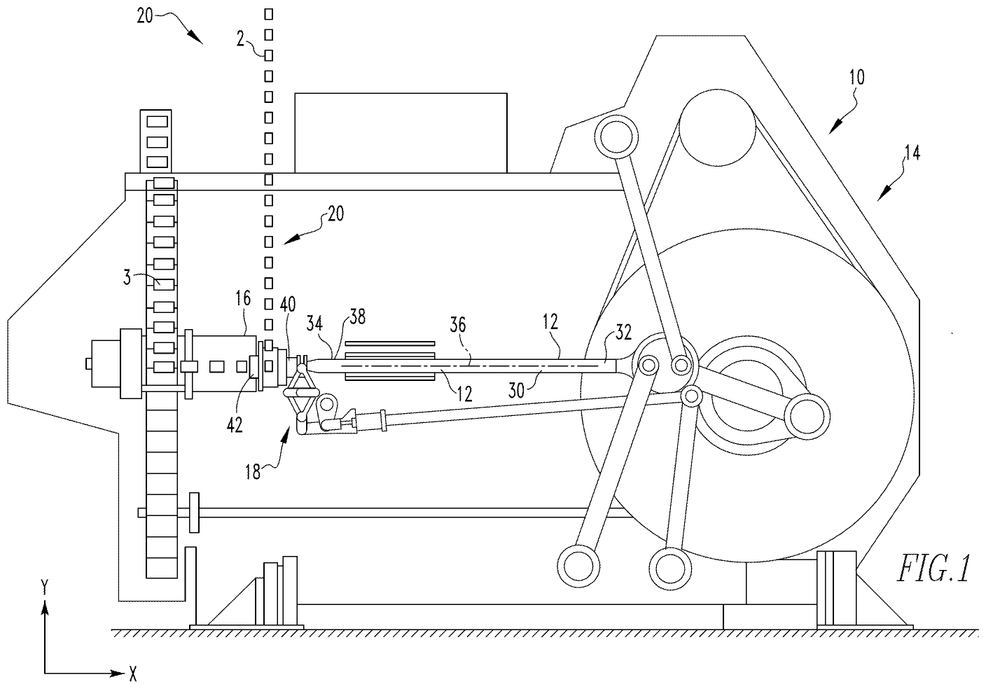

As shown in FIG. 1, a can bodymaker 10 is structured to convert a cup 2 into a can body 3. As described below, the cup 2 is assumed to be substantially circular. It is understood, however, that the cup 2, as well as the resulting can body 3 and elements that interact with the cup 2 or can body 3, may have a shape other than substantially circular. A cup 2 has a bottom member with a depending sidewall defining a substantially enclosed space (none shown). The end of the cup 2 opposite the bottom is open. The can bodymaker 10 includes a reciprocating ram 12, a drive mechanism 14, a die pack 16, a redraw assembly 18 and a cup feeder 20 (shown schematically). That is, the drive mechanism 14 is coupled to the ram 12 and structured to impart a reciprocating motion to the ram 12. As is known, in each cycle the cup feeder 20 positions a cup 2 in front of the die pack 16 with the open end facing the ram 12. When the cup 2 is in position in front of the die pack 16, a redraw sleeve assembly 40, described below, biases the cup 2 against a redraw die 42, described below. The ram 12 has an elongated, substantially circular body 30 with a proximal end 32, a distal end 34, and a longitudinal axis 36. The ram body distal end 34 includes a punch 38. The ram body proximal end 32 is coupled to the drive mechanism 14. The drive mechanism 14 provides a reciprocal motion to the ram body 30 causing the ram body 30 to move back and forth along its longitudinal axis 36. That is, the ram body 30 is structured to reciprocate between a first, retracted position and a second, extended position. In the first, retracted position, the ram body 30 is spaced from the die pack 16. In the second, extended position, the ram body 30 extends through the die pack 16. Thus, the reciprocating ram 12 advances forward (to the left as shown) passing through the redraw sleeve assembly 40, discussed below, and engaging the cup 2. The cup 2 is moved through the redraw die 42 and a number of ironing dies (not shown) within the die pack 16. The cup 2 is converted into a can body 3 within the die pack 16 and then removed therefrom. It is understood that, as used herein, a “cycle” means the cycle of the ram 12 which begins with the ram 12 in the first, retracted position.

Generally, the redraw assembly 18 includes a movable redraw sleeve assembly 40 and a redraw die 42. The redraw die 42 is disposed within the die pack 16 adjacent the redraw sleeve assembly 40. That is, the redraw die 42 is the first die in the die pack 16.

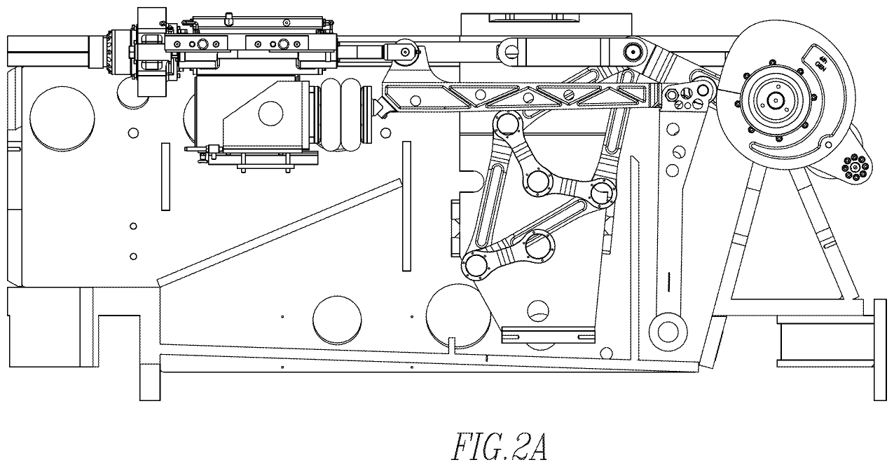

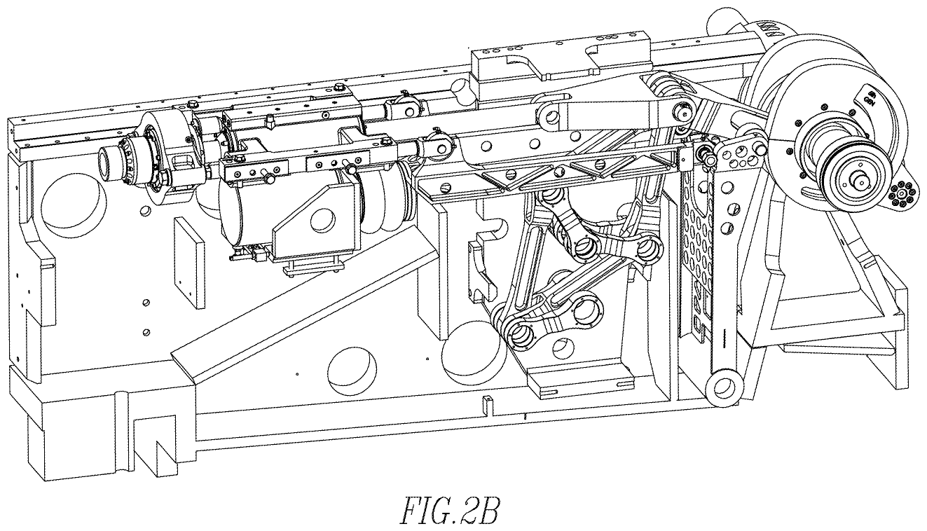

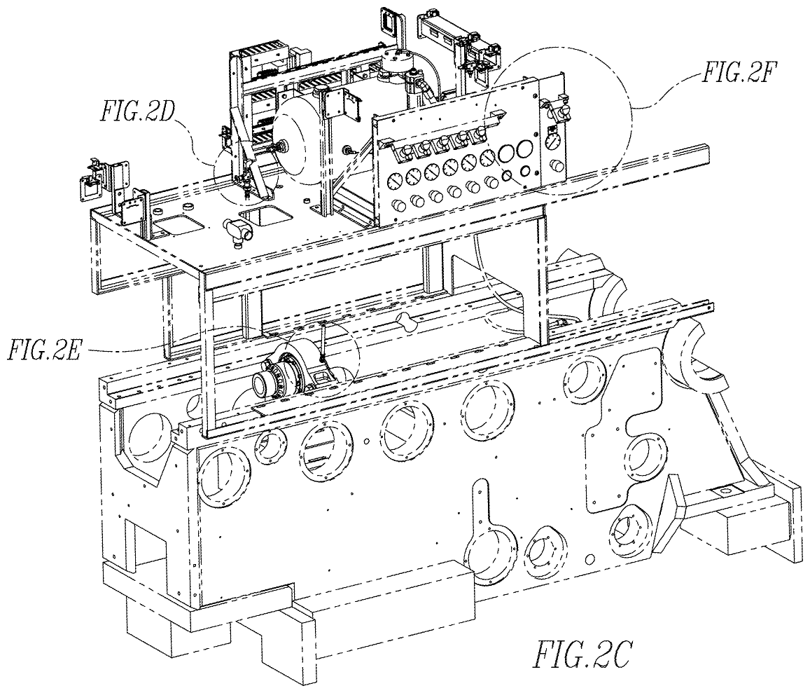

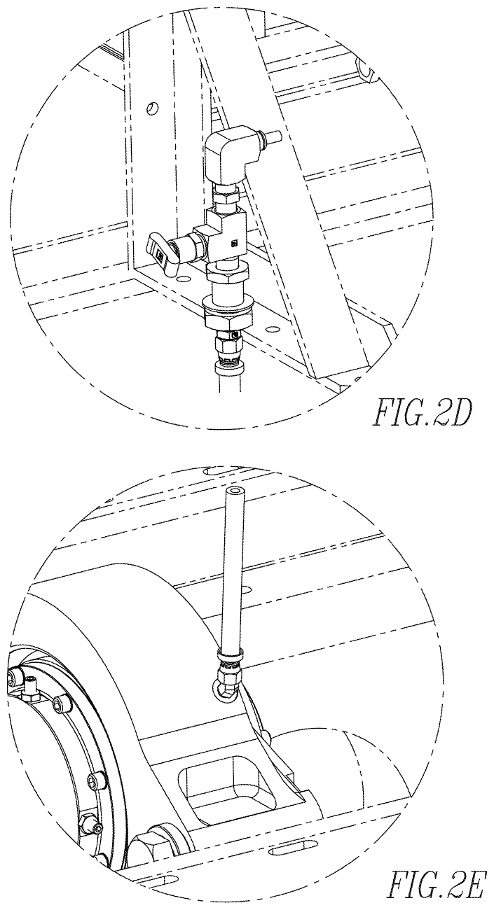

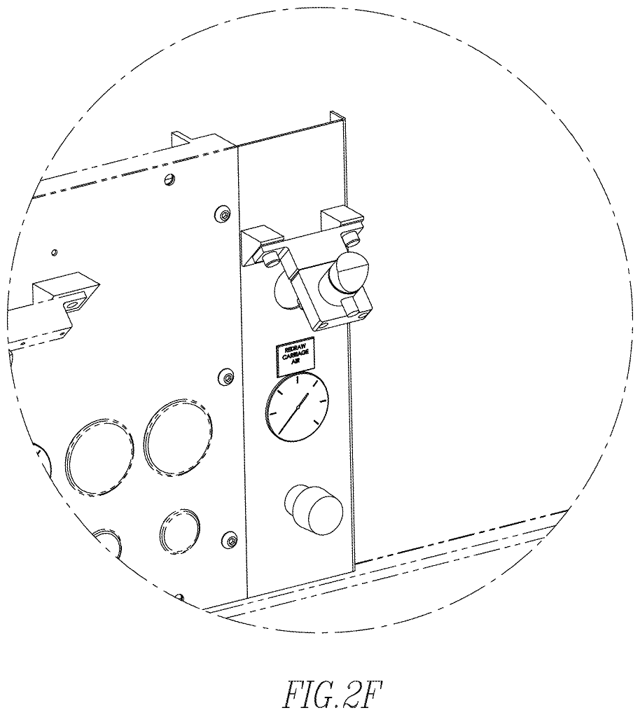

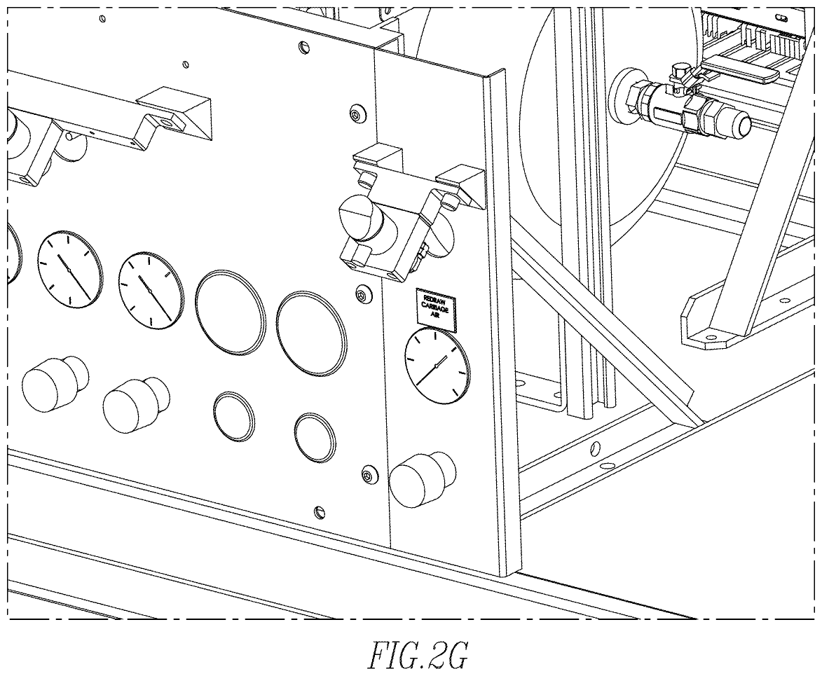

FIGS. 2A and 2B show a bodymaker employing an improved redraw assembly in accordance with one non-limiting embodiment of the disclosed concept. More specifically, FIG. 2A is a side elevation view and FIG. 2B is an isometric view, both of which are shown with the housing of the bodymaker removed to see internal details. In one non-limiting embodiment, the improved redraw assembly may be available in the form of a retrofit kit for use with an existing bodymaker, however, it will be appreciated that in other embodiments the improved redraw assembly may be incorporated into a new bodymaker at the time of initial manufacture. In the example of FIGS. 2A and 2B, the redraw assembly is shown with a linkage configuration, commonly known a “Diamond linkage.” It will be appreciated, however, that other known or suitable alternative linkage configurations (e.g., without limitation, PMA, LPMA) (not shown) could be employed, without departing from the scope of the disclosed concept. As will be discussed, the redraw assembly incorporates numerous improved features over the prior art such as, for example and without limitation, improved hold down assemblies (e.g., without limitation, air spring assemblies) and related features and advantages, an improved redraw carriage assembly and related features and advantages, improved ram guidance system (RGS) and ram guide cradle assembly and related features and advantages, an improved cam follower hold down frame and related features and advantages, and an improved ram bushing assembly and related features and advantages.

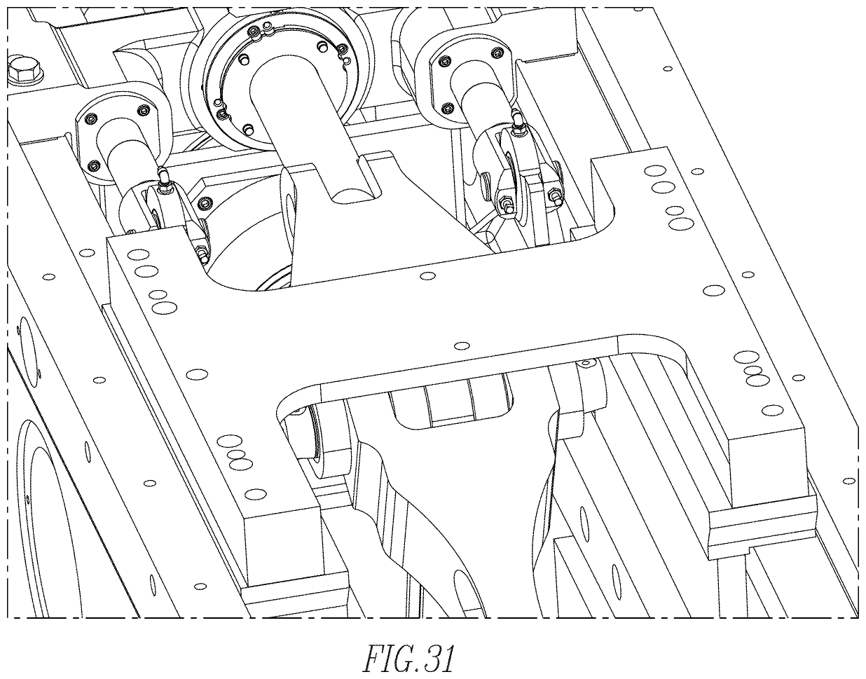

As best shown in FIG. 2B, the redraw assembly incorporates a new push rod design, which is advantageously positioned on the centerline of the bodymaker as opposed to being offset at least partially in accordance with known prior art designs. The centerline position of the push rod is also shown, for example, in the top isometric view of FIG. 31. Among other advantages, such a structure wherein the push rod is centered as opposed to offset, avoids undesired deflection forces that can result in bowing or other undesirable motion in the bodymaker, which consequently can cause inaccuracies in the can body forming process.

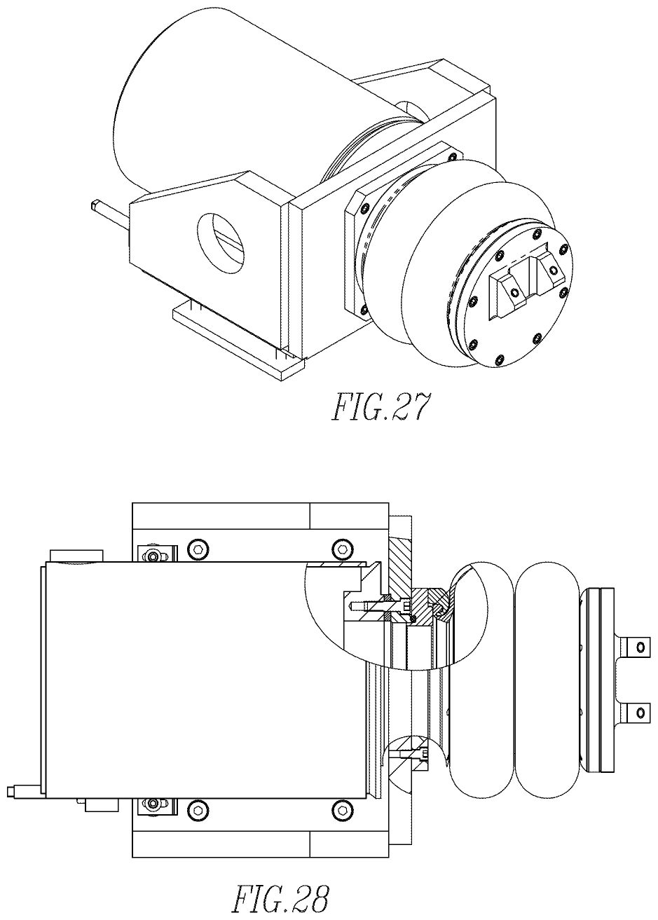

FIG. 2C (partially shown in simplified schematic view) shows the bodymaker incorporating a pneumatic panel in accordance with the one non-limiting example embodiment of the disclosed concept. The pneumatic panel is designed to be easily coupled (e.g., without limitation, bolted) to the existing panel of the bodymaker, as shown. Among other advantages, the pneumatic panel allows for easy adjustment of the redraw sleeve hold down pressure. Additional exemplary features are shown in the enlarged detail views of FIGS. 2D, 2E, 2F and 2G. For example and without limitation, it will be appreciated that the disclosed concept preferably incorporates a surge tank, as shown, instead of an air cylinder. See also FIGS. 27-30, which illustrate an exemplary air spring assembly in accordance with a non-limiting embodiment of the disclosed concept.

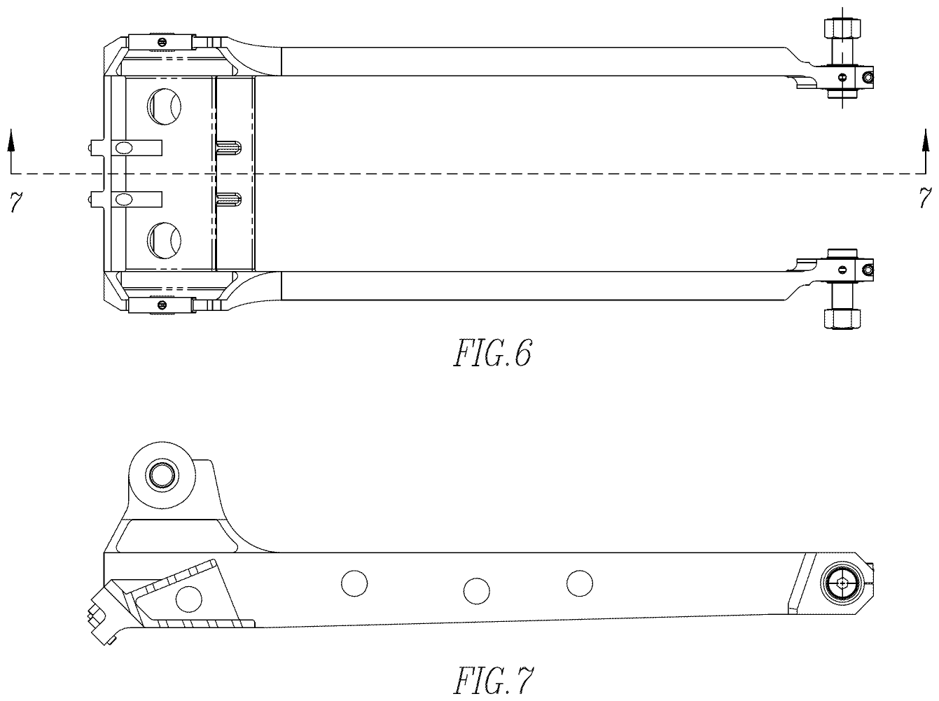

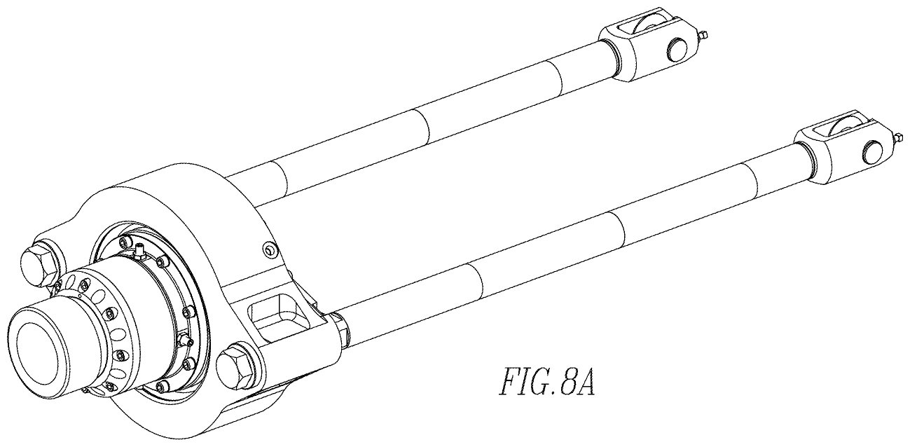

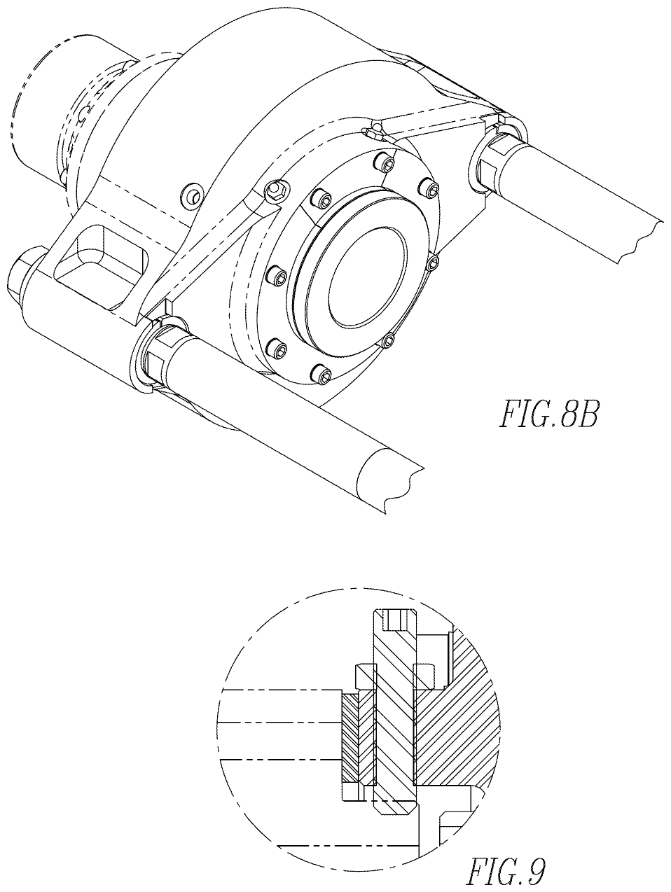

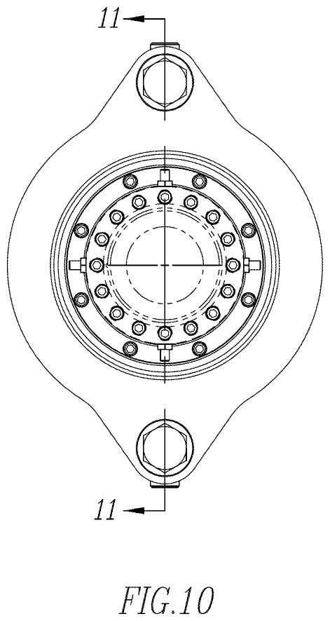

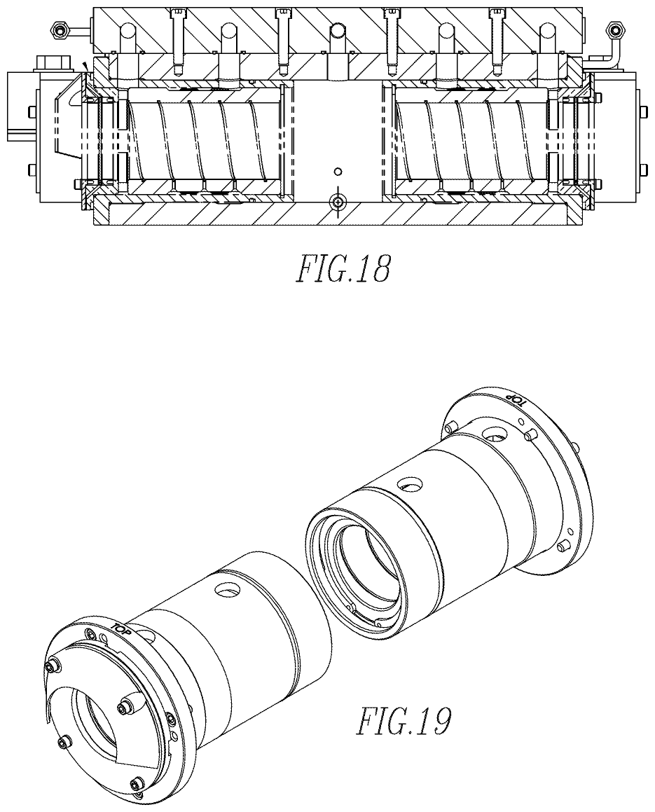

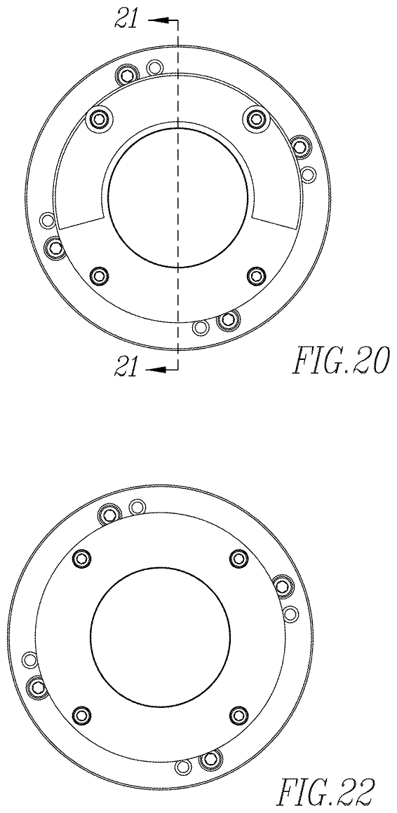

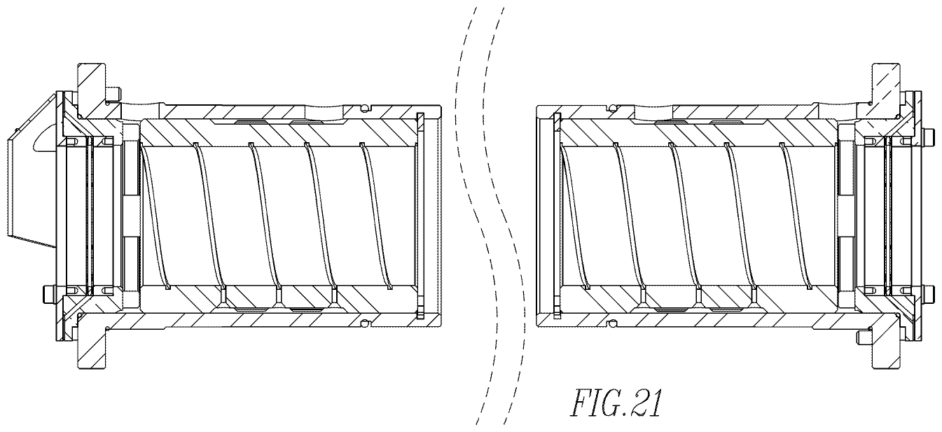

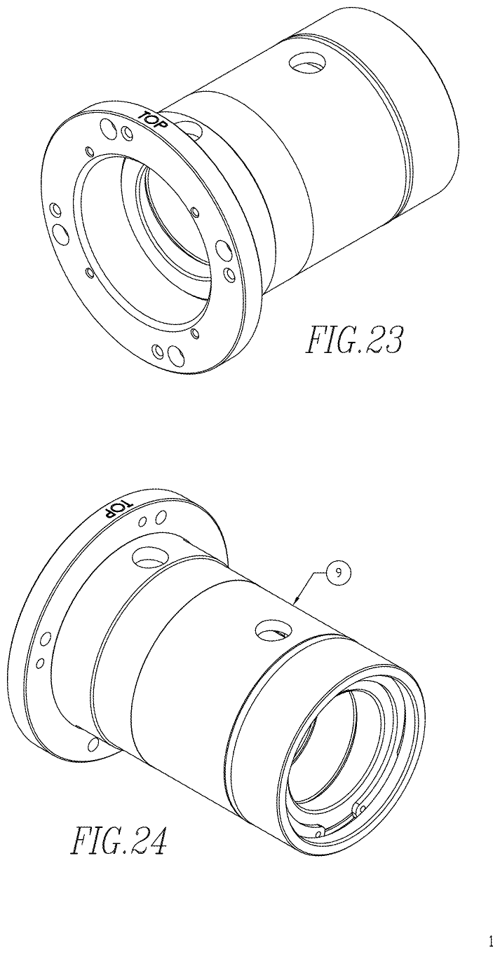

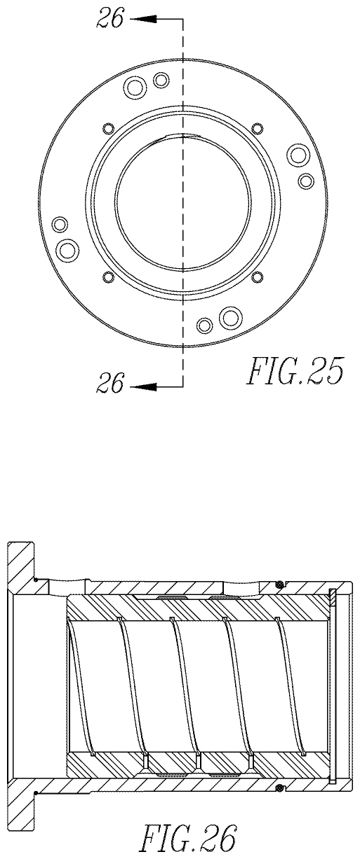

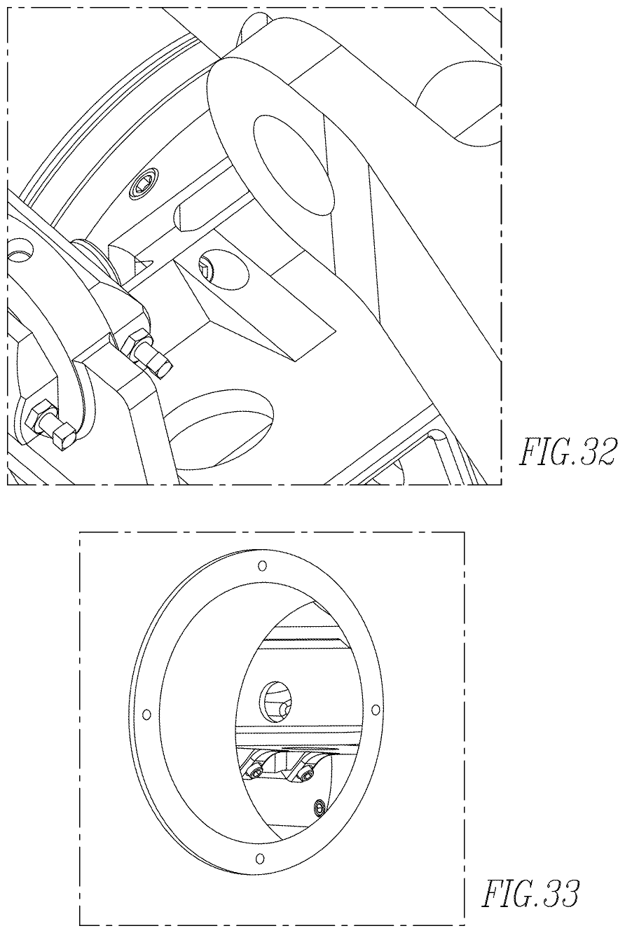

Additional features of the improved redraw assembly will now be further described in greater detail with reference to FIGS. 2A-33.

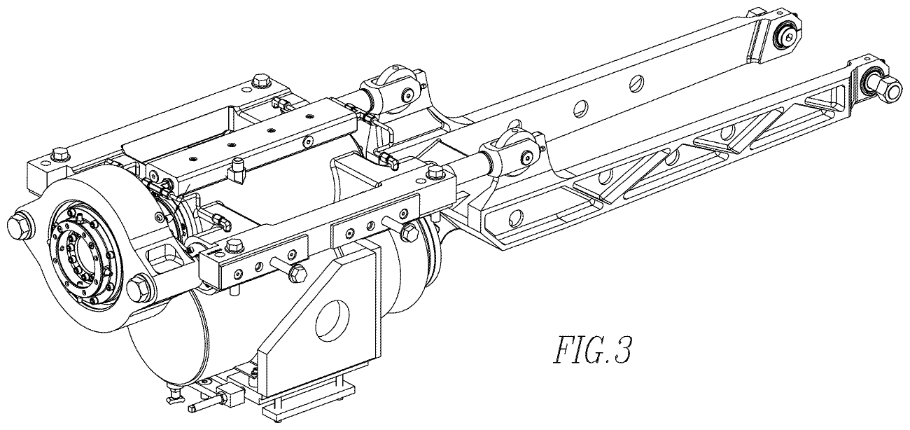

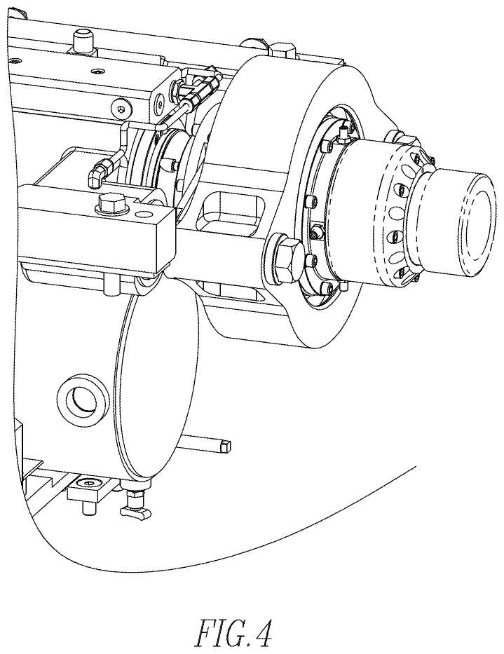

The isometric views of FIGS. 3 and 4 illustrate several features of the exemplary redraw assembly including, for example, a redraw carriage assembly, an air spring or air bag, improved redraw rods and related components, ram bushings, a cam follower hold down frame, and lug bearings, among other features. More specifically, as shown in FIG. 3, the redraw rods are of a robust design and are attached to the unique cam follower hold down frame by clevis assemblies (also shown in FIGS. 8A and 11). The redraw carriage also incorporates a redraw cup clamp that is adjustable, as needed, for proper can forming.

In FIG. 4, an example redraw sleeve is shown, for reference (without limitation). Also partially shown in FIG. 4, is an air spring or air bag inlet. It will be appreciated that the air spring or air bag is in fluid communication with, and is controllable by, the aforementioned redraw pneumatic panel (FIG. 2C; see also the enlarged detailed views of related components in FIGS. 2D-2G). As used herein, the terms “air spring” and “air bag” are used substantially interchangeably and specifically refer to a pneumatically controlled device designed to apply hold down pressure, as opposed to a purely mechanical device (e.g., without limitation, a compression spring). The air spring assembly will be described in greater detail, below, with reference to FIGS. 27-30 as well as FIGS. 31-33.

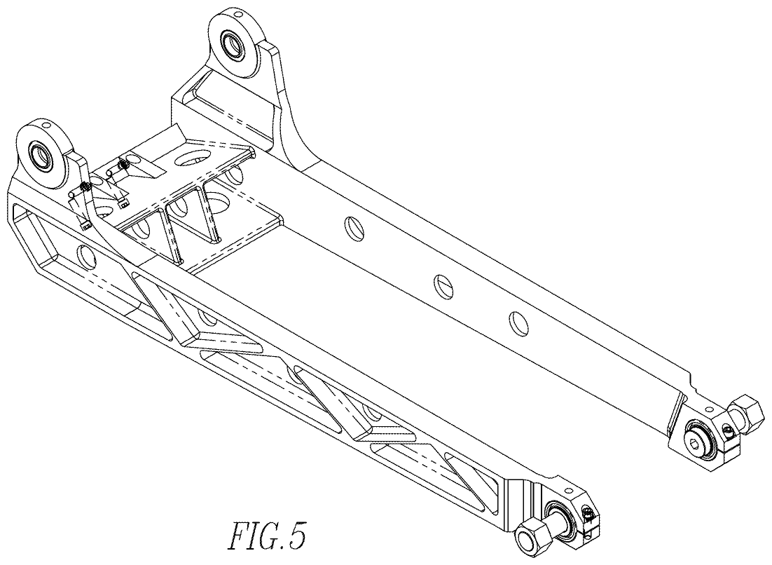

FIGS. 5, 6 and 7 further illustrate the cam follower hold down frame, which forms a key component of the redraw assembly. Specifically, the cam follower hold down frame is uniquely designed to enable the aforementioned centerline position of the push rod, as well as to accommodate the other advantageous features of the redraw assembly shown and described herein. As shown, the cam follower hold down frame preferably comprises a unitary component, preferably made from a single piece of material. The cam follower hold down frame in the example shown is a generally U-shaped member having a pair of elongated legs, which provides a number of mounting locations for other features of the redraw assembly and/or bodymaker. The unique design of the cam follower hold down frame also allows for relatively quick and easy installation, as well as disassembly, for example for maintenance or modification, and then reassembly of the redraw assembly.

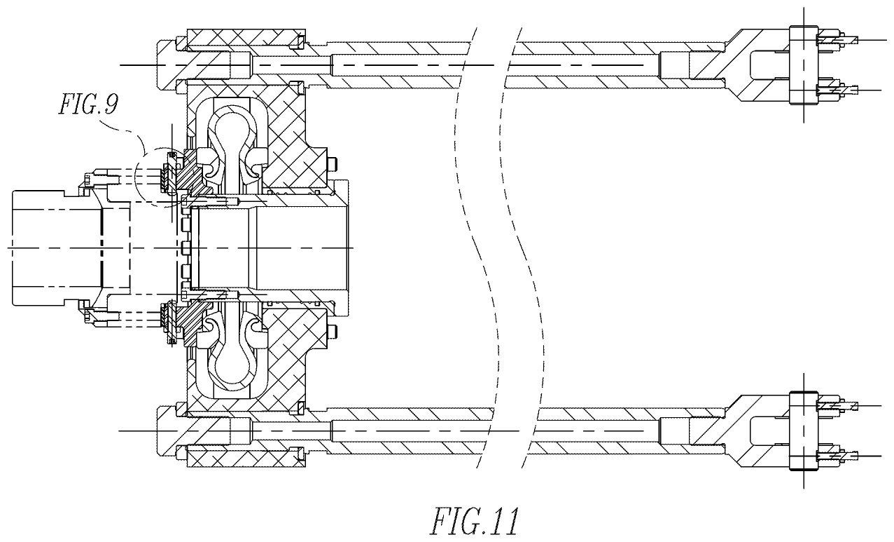

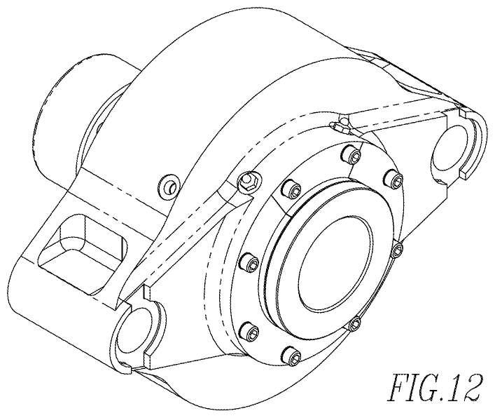

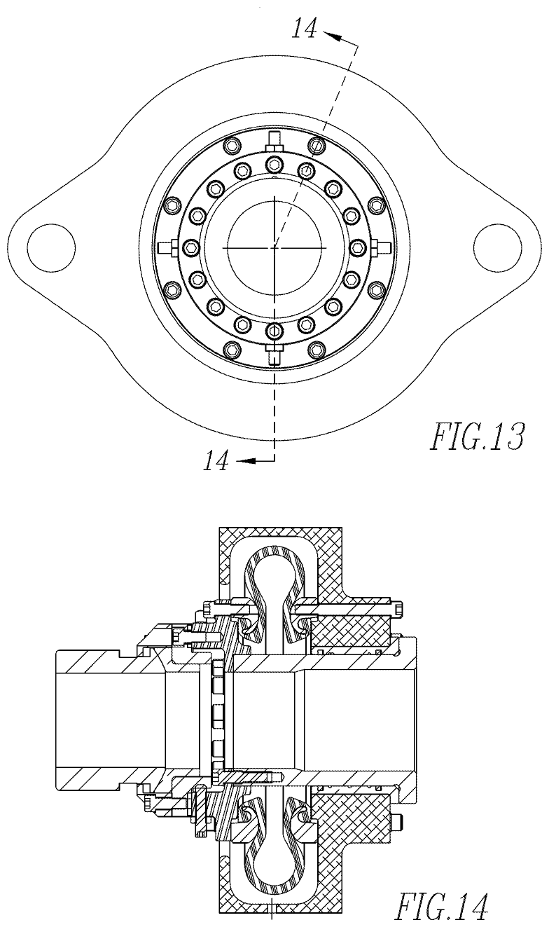

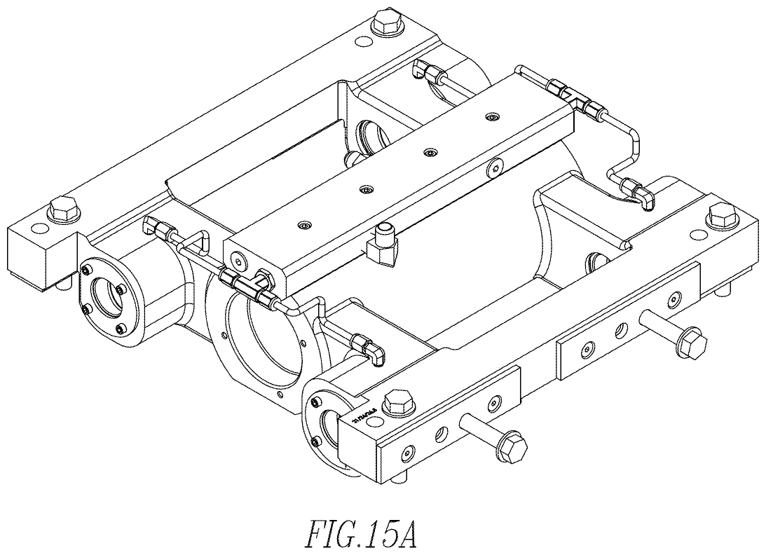

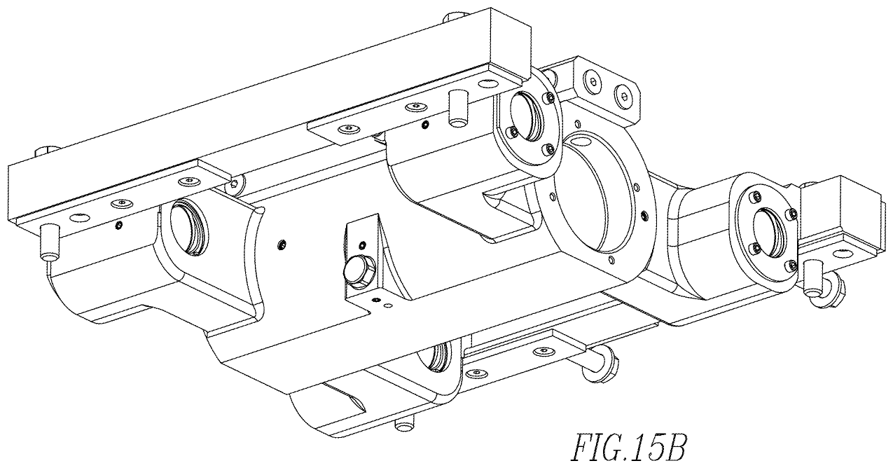

FIGS. 8A-14 illustrate features of the redraw carriage assembly in greater detail. Among other advantages the exemplary carriage assembly includes a number of features designed to remove the heavy oils from the forward portion of the bodymaker. As shown in FIG. 8A, the redraw push rods are robust in design and include clevis assemblies for attachment to the aforementioned cam follower hold down frame (see FIG. 3). The redraw push rods are also designed to cooperate with (e.g., be incorporated into) the improved ram guidance system (RGS) (FIGS. 15A-18). The redraw carriage assembly is designed to be a sealed unit, and among other features includes a grease fitting, an air inlet, and a relief fitting, as shown in FIGS. 8B and 12. Internal features of the redraw carriage are best shown in the section views of FIGS. 11 and 14.

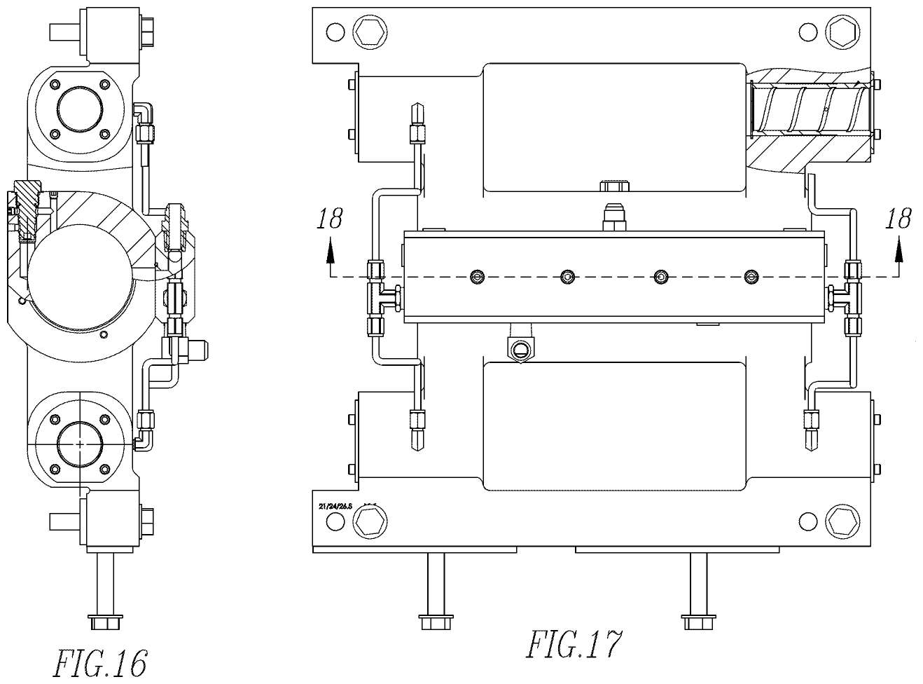

The ram guidance system (RGS) is further illustrated in FIGS. 15A-18. As shown, and as noted above, the exemplary RGS comprises a ram guide cradle assembly designed to cooperate with the redraw push rods (see FIG. 3). The ram guide cradle assembly has bushing assemblies with a number of unique features designed to guide the push rods and maintain a sealed relationship between the push rods and the carriage housing. The carriage housing includes a coolant supply, coolant drain, and coolant supply lines, and is designed to receive arid circulate coolant such that the coolant is advantageously used as a lubricant for the push rods, rather than oil. More specifically, the carriage housing incorporates integrated push rod guide bushings that are lubricated by coolant, not oil. The internal features of the carriage housing are best shown in the partial section views of FIGS. 16 and 17, and the side elevation sectional view of FIG. 18, which clearly shows the bushing assemblies.

Continuing to refer to FIG. 18, and also to FIGS. 19-26, additional details of the improved bushing assemblies can be seen and further appreciated. For example and without limitation, each bushing assembly includes a cartridge assembly, a housing, a drain, a cover plate, and a splash shield, among other unique features. As shown, the housings of the cartridge assemblies include flanges structured to be coupled to the ram guide carriage assembly housing and to provide an effective sealing arrangement. The cartridge assemblies are also structured to advantageously allow for relatively quick and easy removal of components, or for example, to allow replacement of the bushing assemblies, without requiring removal of the ram guide carriage assembly housing. Accordingly, maintenance and modification or repair can be done without requiring major disassembly and downtime. This also means that minimal time is required to do an alignment check, for example, after ram bushing replacement. Additionally, the entire bushing assembly is lubricated with coolant, not oil. Thus, a further, significant advantage of the disclosed redraw assembly is oil savings. Specifically, by removing substantially all heavy oils from the forward portion of the bodymaker, significant cost savings can be achieved. Other benefits include avoiding undesirable mixing of oil with coolant, and the need to address that issue, for example, by skimming off the oil from the coolant. Moreover, significant reduction or elimination of oil consumption has numerous environmental benefits.

Accordingly, it will be appreciated that among other benefits the ram guidance system (RGS) features a carriage housing that, in effect, functions as a coolant manifold and advantageously incorporates bearings into the carriage housing along with replaceable bushings (e.g., without limitation, Peek bushings) and uses coolant for lubrication thereby eliminating oil.

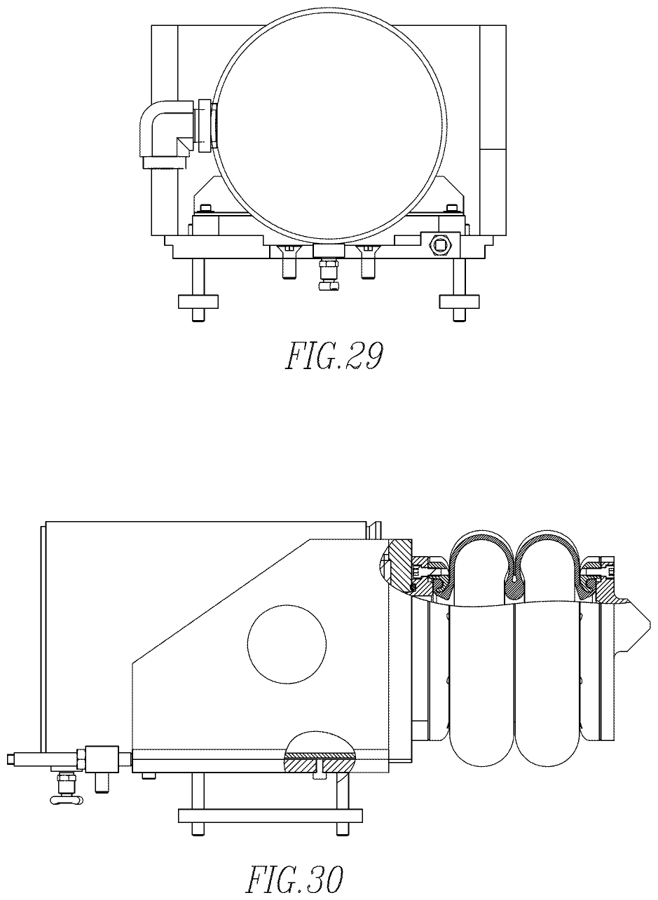

FIGS. 27-33 further illustrate the air spring assembly and related features and advantages. The air spring assembly includes a mounting assembly, a surge tank, and an airbag, among other components. The surge tank is integral with, or is directly coupled to, the airbag, as best shown in FIGS. 27-30 (see also FIGS. 2A, 2B and 3). That is, the surge tank is not connected via a relatively long hose and disposed at a position distal from the air bag, which would not be “directly coupled” or “integral” in accordance with the disclosed concept. The airbag is designed to be relatively easily removed. Features of the airbag, including the mounting thereof, are best shown in the partial section views of FIGS. 28 and 30. Among other advantages, the air spring assembly is also designed to be relatively easily installed, set up, and adjusted. Features that facilitate such installation, set up, and adjustment are shown, for example, in FIGS. 29 and 30, and include for example and without limitation, a locating pin and other adjustment mechanisms. A unique mounting bracket is structured to couple the air spring assembly to the aforementioned cam follower hold down frame, as best shown in FIG. 3, and 31-33. The relatively minimal amount of disassembly and, therefore, easy removal or replacement of the air bag or other components, will also be appreciated with reference to FIGS. 31-33. It will be appreciated that the design of the air spring assembly in accordance with the disclosed concept also lends itself to being capable of being implemented as a retrofit kit for use with existing bodymakers.

Accordingly, it will be appreciated that the disclosed redraw assembly affords many advantages over the prior art.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A redraw assembly comprising:
a carriage assembly;
a ram guidance system;
a hold down assembly; and
a cam follower hold down frame.

2. The redraw assembly of claim 1 wherein the cam follower hold down frame is a generally U-shaped unitary member.

3. The redraw assembly of claim 1 wherein said ram guidance system comprises a ram guide cradle assembly.

4. The redraw assembly of claim 3 wherein said ram guide cradle assembly includes a cradle housing.

5. The redraw assembly of claim 1 further comprising a number of removable ram bushing assemblies.

6. The redraw assembly of claim I wherein the hold down assembly comprises an air spring assembly.

7. The redraw assembly of claim 6 wherein the air spring assembly includes a surge tank.

8. A bodymaker comprising:
a ram;
a die pack;
a drive mechanism coupled to the ram and structured to impart a reciprocating motion to the ram to reciprocate between a first retracted position, wherein the ram is spaced from the die pack, and a second extended position, wherein the ram extends through the die pack; and
a redraw assembly comprising:
a carriage assembly,
a ram guidance system,
a hold down assembly, and
a cam follower hold down frame.

9. The bodymaker of claim 8 wherein the cam follower hold down frame is a generally U-shaped unitary member.

10. The bodymaker of claim 8 further comprising a push rod coupled to the ram; wherein the bodymaker has a longitudinal axis defining a centerline; and wherein the push rod is disposed on the centerline of the bodymaker.
